(19) United States
(12) Patent Application Publication
(10) Pub. No.: US 2011/0138284 A1
(43) Pub. Date: Jun. 9, 2011

(54) THREE-STATE TOUCH INPUT SYSTEM

(75) Inventors: Daniel John Wigdor, Seattle, WA (US); Jarrod Lombardo, Bellevue, WA (US); Annuska Zolyomi Perkins, Redmond, WA (US); Sean Hayes, Lampeter (GB)

(73) Assignee: MICROSOFT CORPORATION, Redmond, WA (US)

(21) Appl. No.: 12/630,381

(22) Filed: Dec. 3, 2009

(51) Int. Cl. G06F 3/033; G06F 3/16; G06F 3/041

(52) U.S. Cl. 715/727; 715/863; 345/173

(57) ABSTRACT

A touch screen input device is provided which simulates a 3-state input device such as a mouse. One of these states is used to preview the effect of activating a graphical user interface element when the screen is touched. In this preview state touching a graphical user interface element on the screen with a finger or stylus does not cause the action associated with that element to be performed. Rather, when the screen is touched while in the preview state audio cues are provided to the user indicating what action would arise if the action associated with the touched element were to be performed.

### BACKGROUND

Touch-sensitive display screens have become increasingly common as an alternative to traditional keyboards and other human-machine interfaces (“HMI”) to receive data entry or other input from a user. Touch screens are used in a variety of devices including both portable and fixed location devices. Portable devices with touch screens commonly include, for example, mobile phones, personal digital assistants (“PDAs”), and personal media players that play music and video. Devices fixed in location that use touch screens commonly include, for example, those used in vehicles, point-of-sale (“POS”) terminals, and equipment used in medical and industrial applications.

The ability to directly touch and manipulate data on a touch-screen has a strong appeal to users. In many respects, touch-screens can be used as a more advantageous input mechanism than the traditional mouse. When using a touch-screen, a user can simply tap the screen directly on the graphical user interface element (e.g., a icon) they wish to select rather than having to position a cursor over the user interface with a mouse.

Touch screens can serve both to display output from the computing device to the user and receive input from the user. The user's input options may be displayed, for example, as control, navigation, or object icons on the screen. When the user selects an input option by touching the associated icon on the screen with a stylus or finger, the computing device senses the location of the touch and sends a message to the application or utility that presented the icon.

### SUMMARY OF THE INVENTION

Conventional touch screen input devices can be problematic for visually impaired users because they are not able to visually judge the alignment of their finger or stylus with the desired graphical user interface element appearing on the screen prior to contacting it. In addition, they do not have a means to verify the impact of touching the screen prior making contact with it, by which time the underlying application will have already acted in response to that contact.

To overcome this limitation, in one implementation a touch screen input device is provided which simulates a 3-state input device such as a mouse. One of these states is used to preview the effect of activating a graphical user interface element when the screen is touched. In this preview state touching a graphical user interface element on the screen with a finger or stylus does not cause the action associated with that element to be performed. Rather, when the screen is touched while in the preview state audio cues are provided to the user indicating what action would arise if the action associated with the touched element were to be performed.

In some implementations, once the user has located a graphical user interface element that he or she desires to select, the user can place a second finger or stylus on the touch screen while the first finger or stylus maintains contact with the element. In this way the desired graphical user interface element can be activated. That is, placing the touch screen in the second state by making contact with a second finger or stylus causes the underlying application to respond as it would when that element is selected using a conventional input device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an illustrative portable computing environment in which a user interacts with a device using a touch screen for receiving user inputs.

FIG. 2 shows various illustrative form factors of a computing device in which a touch screen may be employed.

FIG. 3 shows the state diagram for a conventional mouse input device.

FIG. 4 shows the state diagram for a conventional touch screen input device.

FIG. 5 shows one example of a state diagram for a 3-state touch screen input device.

FIG. 6 shows a user's finger touching a touch screen that presents a menu of options.

FIG. 7 shows the user's finger in FIG. 6 touching the option labeled “ScatterView.”

FIG. 8 shows a finger touching the touch screen shown in FIGS. 6-7, which causes a circle to be presented on the touch screen centered about the location where the finger makes contact with the screen.

FIG. 9 shows a second finger touching the touch screen shown in FIG. 8 in order to activate the selected graphical user interface element.

FIG. 10 is an illustrative architecture that shows the functional components that may be installed on a computing device that employs a touch screen for receiving user inputs.

### DETAILED DESCRIPTION

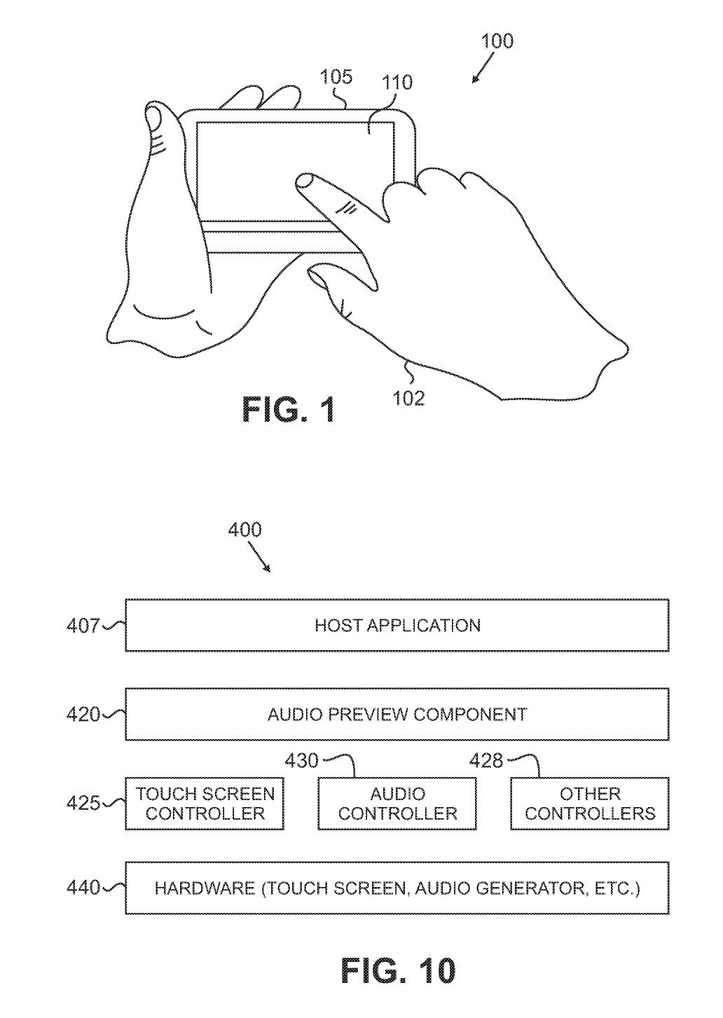

FIG. 1 shows an illustrative portable computing environment 100 in which a user 102 interacts with a device 105 using a touch screen 110 for receiving user inputs. Device 105, as shown in FIG. 1, is commonly configured as a portable computing platform or information appliance such as a mobile phone, smart phone, PDA, ultra-mobile PC (personal computer), handheld game device, personal media player, and the like. Typically, the touch screen 110 is made up of a touch-sensor component that is constructed over a display component. The display component displays images in a manner similar to that of a typical monitor on a PC or laptop computer. In many applications, the device 105 will use a liquid crystal display (“LCD”) due to its light weight, thinness, and low cost. However, in alternative applications, other conventional display technologies may be utilized including, for example, cathode ray tubes (“CRTs”), plasma-screens, and electro-luminescent screens.

The touch sensor component sits on top of the display component. The touch sensor is transparent so that the display may be seen through it. Many different types of touch sensor technologies are known and may be applied as appropriate to meet the needs of a particular implementation. These include resistive, capacitive, near field, optical imaging, strain gauge, dispersive signal, acoustic pulse recognition, infrared, and surface acoustic wave technologies, among others. Some current touch screens can discriminate among multiple, simultaneous touch points and/or are pressure-sensitive. Interaction with the touch screen 110 is typically accomplished using fingers or thumbs, or for non-capacitive type touch sensors, a stylus may also be used.

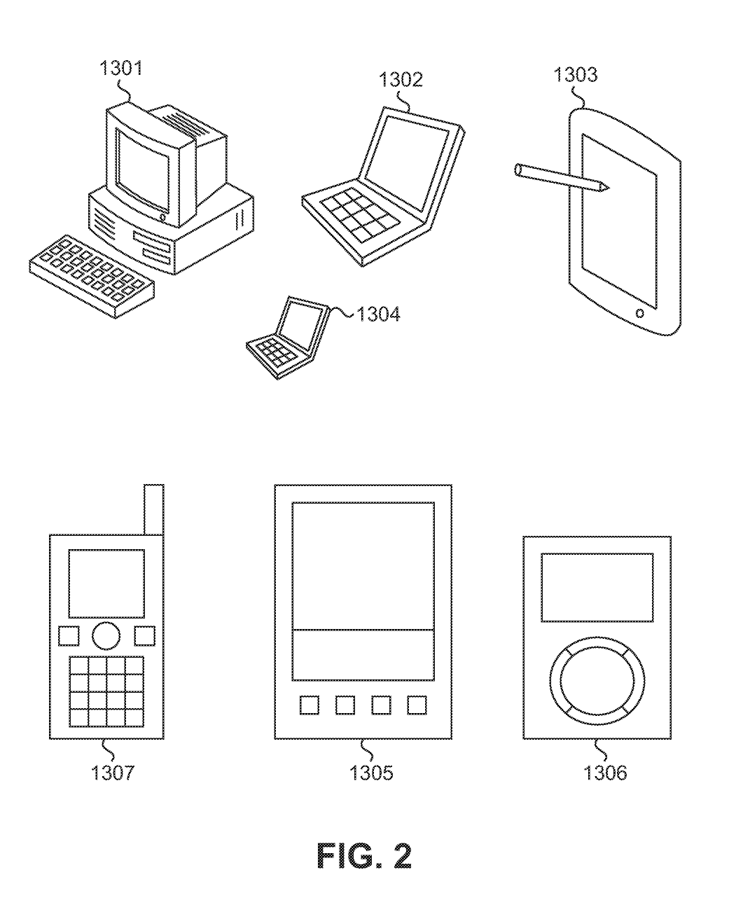

Other illustrative form factors in which the computing device may employed are shown in FIG. 2, including desktop computers 1301, notebook computers 1302, tablet computers 1303, handheld computers 1304, personal digital assistants 1305, media players 1306, mobile telephones 1307, and the like. Additionally, the computer may be a combination of these types, for example, a device that is a combination of a personal digital assistant, media player, and mobile telephone.

While many of the form-factors shown in FIGS. 1 and 2 are portable, the present arrangement may also be used in any fixed computing device where touch screens are employed. These devices include, for example, automatic teller machines (“ATMs”), point-of-sale (“POS”) terminals, or self-service kiosks and the like such as those used by airlines, banks, restaurants, and retail establishments to enable users to make inquiries, perform self-served check-outs, or complete other types of transactions. Industrial, medical, and other applications are also contemplated where touch screens are used, for example, to control machines or equipment, place orders, manage inventory, etc. Touch screens are also becoming more common in automobiles to control subsystems such as heating, ventilation and air conditioning (“HVAC”), entertainment, and navigation. The new surface computer products, notably Microsoft Surface™ by Microsoft Corporation, may also be adaptable for use with the present input device.

In order to facilitate an understanding of the methods, techniques and systems described herein, it may be helpful to compare the operation of a conventional mouse with a conventional touch screen input device using state diagrams to model their functionality.

First, when a mouse is out of its tracking range (such as occurs when a mechanical mouse is lifted off a surface), the mouse is in a state 0 that may be referred to as out-of-range. Next, consider a mouse that is within its tracking range but without any of its buttons being depressed. This state may be referred to as tracking, which describes a state in which a cursor or pointer appearing on the screen follows the motion of the mouse. The tracking state may be referred to as state 1. In the tracking state the cursor or pointer can be positioned over any desired graphical user interface element by moving the mouse. The mouse can also operate in a second state (referred to as state 2) when a button is depressed. In this state, which can be referred to as dragging, graphical user interface elements or objects are moved (“dragged”) on the display so that they follow the motion of the mouse. It should be noted that the act of selecting an icon may be considered a sub-state of the dragging state since selecting involves depressing and releasing a button.

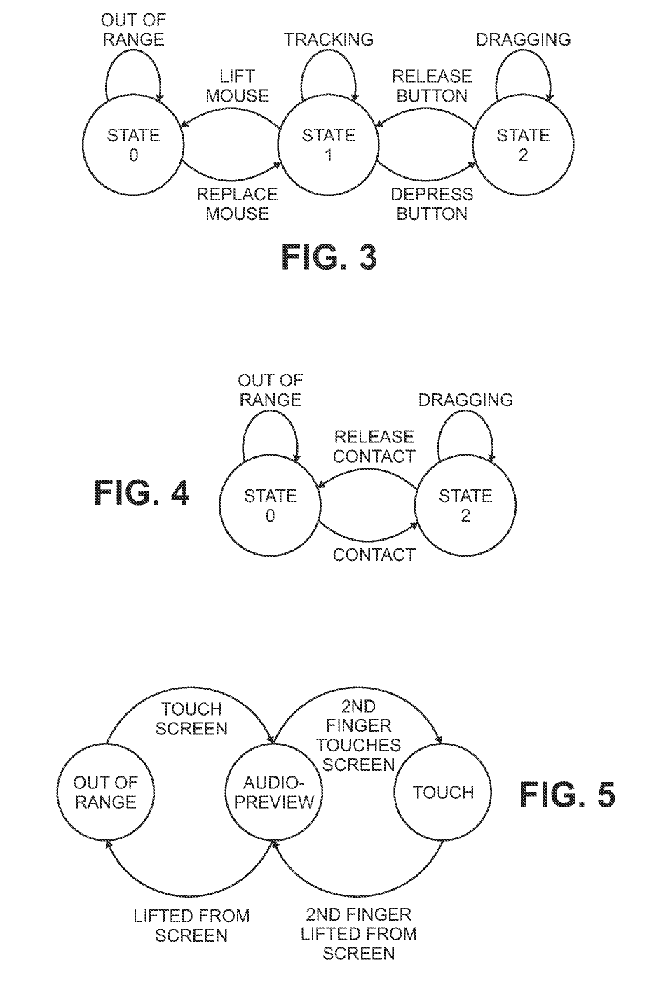

FIG. 3 shows the state diagram for the mouse described above. In state 0 the mouse is out of range and in state 1 it is in the tracking state. The mouse can enter the state 1 from state 0 by bringing it back into range. In the case of a mechanical mouse, this involves returning the mouse to a surface such as a mousepad. The mouse can enter state 2 from state 1 by depressing (“clicking”) a button. The mouse can also return to state 1 from state 2 by releasing the button.

FIG. 4 shows the state diagram for a conventional touch screen input device, which is assumed to be only capable of sensing one bit of pressure, namely touch or no-touch. While a mouse has three states, the touch screen input device only has two states, which correspond to the state 0 (out-of-range) and the state 2 (dragging). That is, the conventional touch screen input device does not have a tracking state.

The lack of a tracking state in a conventional touch screen input device can be overcome by sighted users because they are able to visually judge the alignment of their finger or stylus with the desired graphical user interface element appearing on the screen prior to contacting it. Visually impaired users, however, do not have a means to verify the impact of touching the screen prior making contact with it, by which time the underlying application will have already acted in response to that contact.

To overcome this limitation, a touch screen input device is provided which simulates a 3-state input device such as a mouse. The additional state is used to preview the effect of entering state 2 when the screen is touched. In this preview state touching a graphical user interface element on the screen does not cause the action associated with that element to be performed. Rather, when the screen is touched while in the preview state audio cues are provided to the user indicating what action would arise if the touch screen input device were to be in state 2.

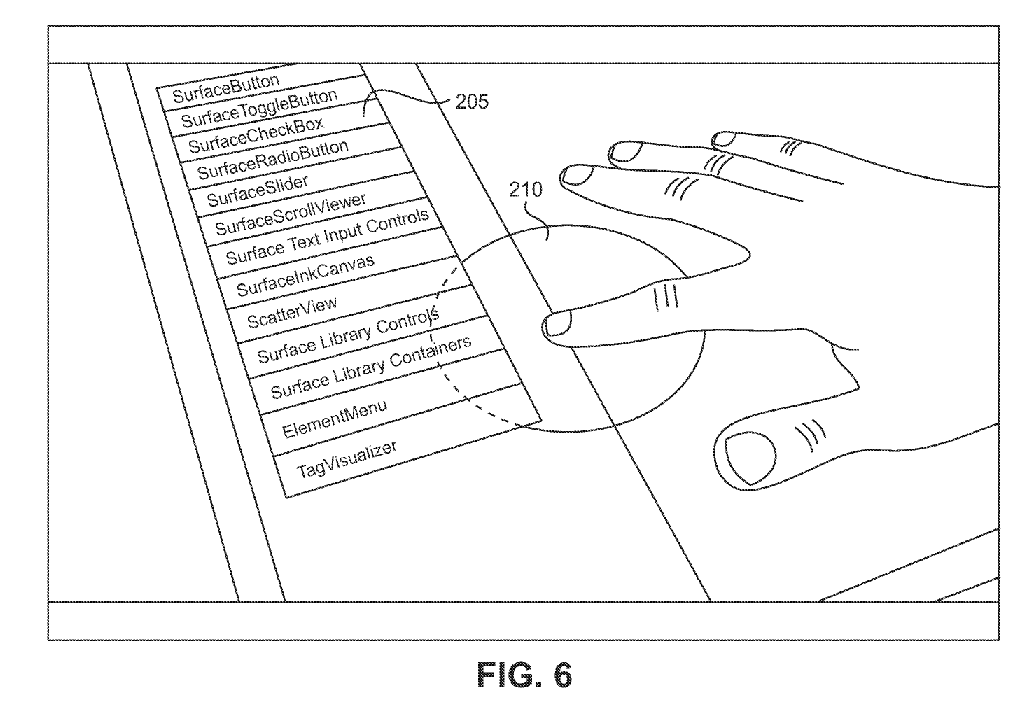

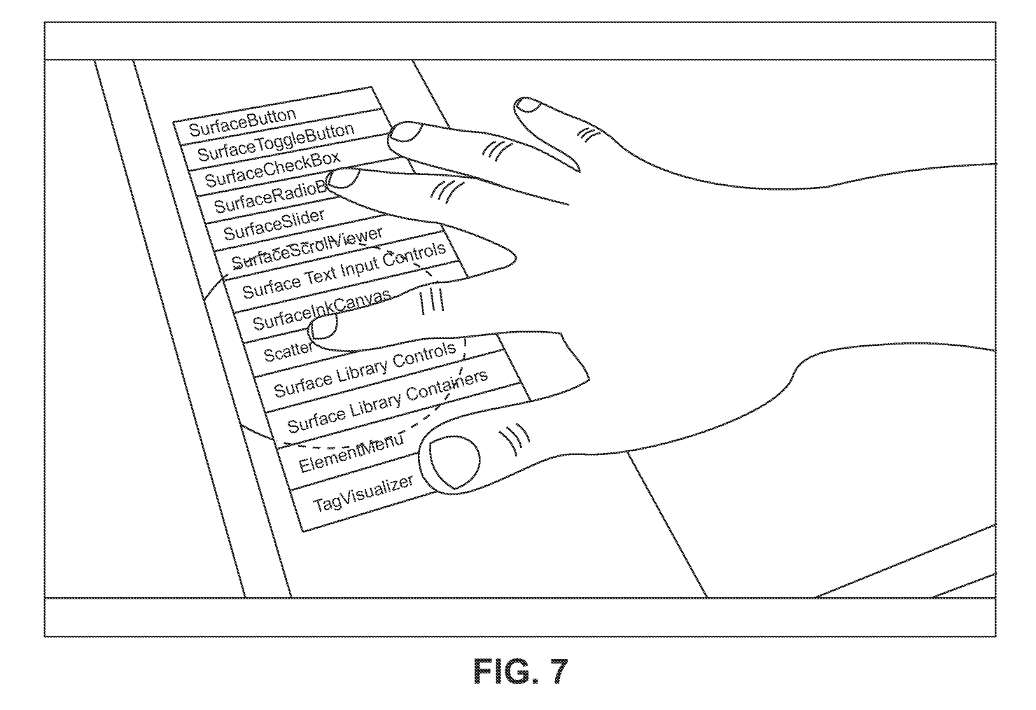

FIG. 5 shows one example of a state diagram for the 3-state touch screen input device. States 0 and 2 correspond to states 0 and 2 shown in FIG. 4. It should be noted, however, that for the sake of generality state 2 in FIG. 5 is referred to as the touch state, which may include actions such as dragging and selecting the graphical user interface element that is being touched. For instance, the second state may allow a graphical user interface element to be dragged on the touch screen in response to movement of the first touch along the touch screen. In addition to these two states, a new state, state 1, is also provided, which in some implementations may be referred to as an audio-preview state. The audio preview state may be entered from the out-of-range state (state 0) by touching the screen with a single finger or stylus. As various graphical user interface elements are contacted while in this state an audio cue is provided describing the function of the element that is being contacted. For example, as shown in FIG. 6, a user's finger is received by a touch screen that is used with the Microsoft Surface™ computer product. The finger is touching a screen that presents a menu 205 of options. As result of receipt of the finger on the touch screen, a circle 210 is generated on the touch screen. In FIG. 7 the finger touches the option labeled “ScatterView.” In response to the touch, an audio cue is generated that says “ScatterView.”

Once the user has located a graphical user interface element that he or she desires to select, the user can enter state 2 by placing a second finger or stylus on the touch screen while the first finger or stylus maintains contact with the element. In this way the desired graphical user interface element can be activated. That is, placing the touch screen in the second state by making contact with a second finger or stylus causes the underlying application to respond as it would when that element is selected using a conventional input device.

As indicated in FIG. 5, the user may exit the second state by lifting the second finger or stylus from the touch screen, which returns the screen to the audio preview state. That is, detecting the absence of the second finger or stylus returns the screen to the audio preview state.

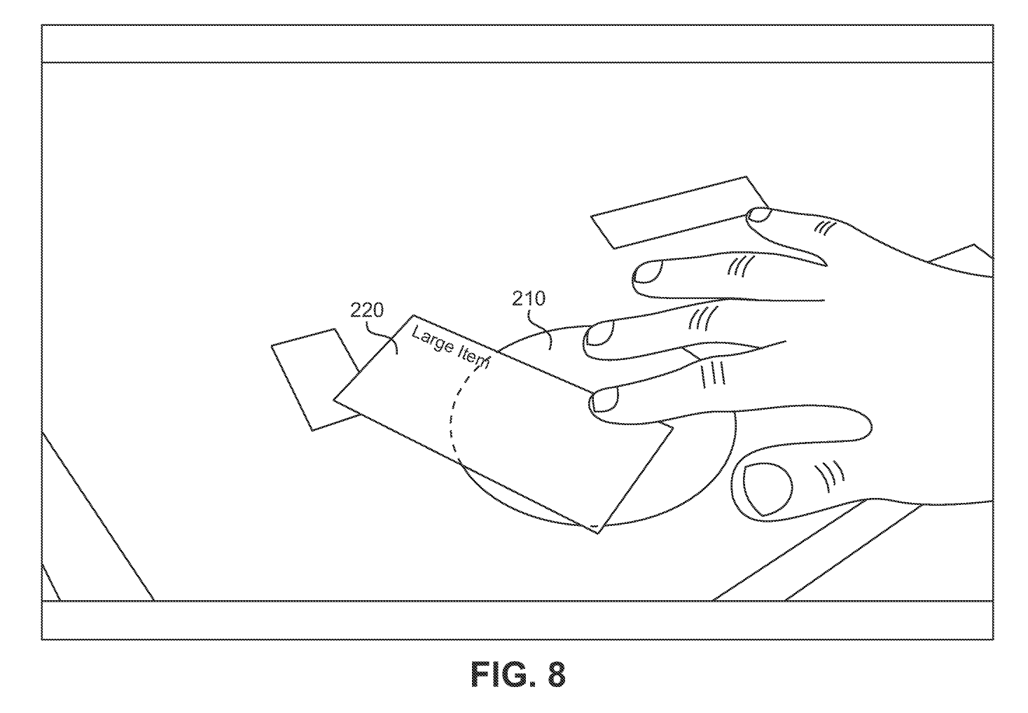

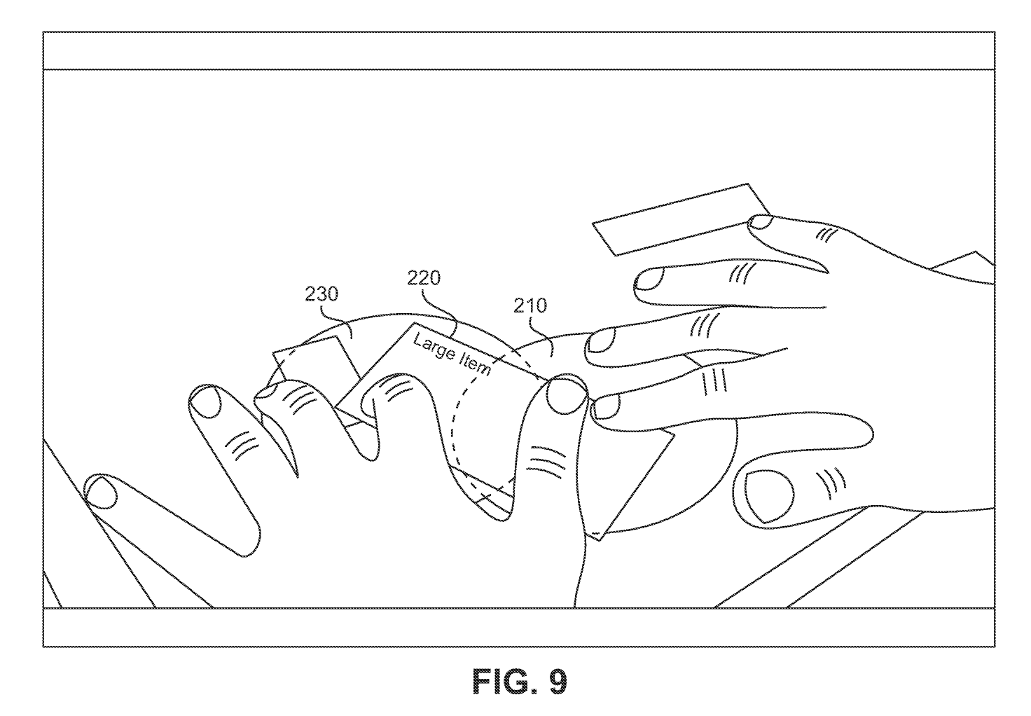

In some implementations the touch state can be entered from the audio preview state by placing the second finger or stylus anywhere on the screen or, alternatively, on a predefined portion of the screen. In other implementations the user makes contact with the screen in close proximity with the first finger or stylus. For instance, in some cases the second finger or stylus makes contact within a predefined distance from the first finger or stylus. One such example is shown in FIG. 8. In this example, a circle 210 is presented on the touch screen centered about the location where the first finger or stylus makes contact with the screen in order to enter the touch state. The finger is contacting a rectangle 220 labeled “Large Item.” Upon touching the rectangle 220 the audio cue “Large Item” is presented to the user. In order to enter the touch state, the user uses a second finger or stylus to make contact with the screen within the circle 210 that is displayed. FIG. 9 shows this input device in the touch state. The second finger gives rise to circle 230, which as shown overlaps circle 210.

FIG. 10 is an illustrative architecture 400 that shows the functional components that may be installed on a computing device that employs a touch screen for receiving user inputs. The functional components are alternatively implementable using software, hardware, firmware, or various combinations of software, hardware, and firmware. For example, the functional components in the illustrative architecture 404 may be created during runtime through execution of instructions stored in a memory by a processor.

A host application 407 is typically utilized to provide a particular desired functionality. However, in some cases, the features and functions implemented by the host applications 407 can alternatively be provided by the device's operating system or middleware. For example, file system operations and input through a touch screen may be supported as basic operating system functions in some implementations.

An audio preview component 420 is configured to expose a variety of input events to the host application 407 and functions as an intermediary between the host application and the hardware-specific input controllers. These controllers include a touch screen controller 425, an audio controller 430 and possibly other input controllers 428 (e.g., a keyboard controller), which may typically be implemented as device drivers in software. Touch screen controller 425 interacts with the touch screen, which is abstracted in a single hardware layer 440 in FIG. 11. Among other functions, the touch screen controller 425 is configured to capture data indicative of touch coordinates and/or pressure being applied to the touch screen and sending the captured data back to the audio preview component 420, typically in the form of input events.

Thus, the audio preview component 420 is arranged to receive input events such as physical coordinates from the touch screen controller 425. The nature of the input events determines the state of the touch screen. That is, the manner in which the user contacts the screen with one or two fingers or styluses determines if the screen is in the out-of-range, audio preview or touch state. In the preview state, the audio preview component 420 then formulates the appropriate calls to the host application in order to obtain information concerning the functionality performed by the graphical user interface element that is being touched or contacted. For instance, if the host application 407 allows programmatic access, the audio preview component 420 can extract data in the host application 407 that identifies the graphical user interface element that the user has selected in either the audio preview state or the touch state. If the audio preview component 420 cannot programmatically access the contents of the host application 407, the host program may need to be written to incorporate appropriate APIs that can expose the necessary information to the audio preview component 420. The extracted data, typically in form of text, can undergo text-to-speech conversion using a text-to-speech converter or module accessed by the audio preview component 420. Alternatively, the extracted data may be used to generate audio data that is indicative of the function performed by activation of the graphical user interface element that is being touched or contacted. For instance, in some cases a distinct tone may be used to represent commonly used graphical user interface elements such as “save,” “close,” and the like. The audio preview component 420 can then expose the audio data to audio controller 434, which can send a drive signal to an audio generator in hardware layer 440 so that the audio can be rendered.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a machine-readable computer program accessible from any computer-readable device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize that many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of providing a user interface for a mobile device, comprising:
displaying one or more graphical user interface elements on a touch-screen;
receiving a first touch on the touch-screen at a location of the graphical user interface element; and
responding to receipt of the first touch by entering a preview state in which an audio cue is rendered indicating a function performed by the graphical user interface element.

2. The method of claim 1 further comprising:
receiving a second touch on the touch-screen while continuing to receive the first touch; and
responding to receipt of the second touch by entering a second state associated with the graphical user interface element that is different from the preview state.

3. The method of claim 2 wherein the second state allows the graphical user interface element to be dragged on the touch screen in response to movement of the first touch along the touch screen while in the second state.

4. The method of claim 2 wherein the second state is only entered if the second touch is received on a predefined portion of the touch-screen.

5. The method of claim 2 wherein the second state is only entered if the second touch is received on a portion of the touch screen that is less than a predefined distance away from the location at which the first touch is received.

6. The method of claim 1 wherein the graphical user interface element represents a portion of a user interface to an application that is executed on an electronic device and the function performed by the graphical user interface element causes the application to respond in a predefined manner.

7. The method of claim 6 wherein entering the preview state does not cause the application to respond in accordance with the function performed graphical user interface element.

8. The method of claim 2 further comprising:
detecting an absence of the second touch; and
in response to the absence of the second touch, returning to the preview state.

9. A touch screen display system for use in an electronic device, comprising:
a touch screen configured to receive user input and display one or more graphical user interface elements; and
an audio preview component configured to respond to receipt of a first touch on the touch screen at a location of the graphical user interface element by entering a preview state in which an audio cue is rendered indicating a function performed by the graphical user interface element.

10. The touch screen display system of claim 9 further comprising an application residing on the electronic device, the application having a user interface that includes the graphical user interface element, and wherein the audio preview component includes a text-to-speech converter component for converting text associated with the graphical user interface element into the audio cue, said text being exposed to the audio preview component by the application.

11. The touch screen display system of claim 9 further comprising a touch screen controller configured to respond to receipt of a second touch on the touch screen while continuing to receive the first touch by entering a second state associated with the graphical user interface element that is different from the preview state.

12. The touch screen display system of claim 11 wherein the second state allows the graphical user interface element to be dragged on the touch screen in response to movement of the first touch along the touch screen.

13. The touch screen display system of claim 11 wherein the second state is only entered if the second touch is received on a predefined portion of the touch-screen.

14. The touch screen display system of claim 11 wherein the second state is only entered if the second touch is received on a portion of the touch screen that is less than a predefined distance away from the location at which the first touch is received.

15. The touch screen display system of claim 9 further comprising an application residing on the electronic device, the application having a user interface that includes the graphical user interface element, wherein a function performed by the graphical user interface element causes the application to respond in a predefined manner.

16. A medium comprising instructions executable by a computing system, wherein the instructions configure the computing system to perform a method of interpreting a user contact on a touch screen, comprising:
presenting on a touch screen a graphical user interface element associated with the application; and
in response to user contact with a portion of the touch screen at which the graphical user interface element is located, generating an audio response that indicates an action performed by the application in response to selection of the graphical user interface element.

17. The medium of claim 16 wherein the audio response includes speech.

18. The medium of claim 17 wherein the speech identifies a function performed by activation of the graphical user interface element.

19. The medium of claim 16 wherein the graphical user interface element represents a portion of a user interface to an application that is executed on an electronic device and the function performed by the graphical user interface element causes the application to respond in a predefined manner.

20. The medium of claim 19 wherein the user contact does not cause the application to respond in accordance with the function performed by the graphical user interface element.
